(19) United States
(12) Patent Application Publication
(10) Pub. No.: US 2025/0134298 A1
(43) Pub. Date: May 1, 2025

(54) PACKS FOR BEVERAGE PREPARATION SYSTEM

(71) Applicant: SOCIETE DES PRODUITS NESTLE S.A., Vevey (CH)

(72) Inventors: MARILYNE ISABELLE BONIN, Les Grangettes (FR); GINA FIORE, Ferlens (CH)

(21) Appl. No.: 18/833,483

(22) PCT Filed: Jan. 27, 2023
(86) PCT No.: PCT/EP2023/051999

§ 371 Date: Jul. 26, 2024

(30) Foreign Application Priority Data
Jan. 28, 2022 (EP) 22153945.5

(51) Int. Cl. A47J 31/40; B65D 85/804

(52) U.S. Cl. CPC A47J 31/407; B65D 85/8043

(57) ABSTRACT

The invention concerns a beverage production system comprising a pack (10) and a module (1) for producing a beverage from the pack, —said pack (10) comprising an area (104) configured for being openable, and —said module (1) comprising: a fluid processing device (11) comprising an upwardly pointed end (114), and at least one internal inlet conduit (111) for introducing a fluid into said pack for the preparation of a beverage by mixing said fluid with an ingredient contained in said pack, and at least one internal outlet conduit (112) for dispensing said beverage from said pack, and. an actuating device (12) to move said fluid processing device (11) and said pack (10) one to the other wherein the openable area (104) of the pack is made of a film of material, said film of material being first stretchable around the upwardly pointed end (114), and then pierceable by the upwardly pointed end and during the upward movement of the fluid processing device through the openable area (104).

### FIELD OF THE INVENTION

The present invention relates to a beverage system using packs of beverage ingredient.

### BACKGROUND OF THE INVENTION

WO 20211/10652 describes a beverage preparation machine for the preparation of beverages from containers holding beverage ingredients. The machine comprises a needle designed to pierce the bottom of a container and to protrude inside the container so as to introduce water therein through a water inlet and then to dispense the beverage resulting from the mixing of the ingredient and water though a beverage channel defined by the needle.

The container is hold essentially vertically and the needle pierces the bottom face of the container from below. Usually, the needle pierces a specific openable area of the bottom face of the container. Depending on the configuration and nature of the material of this openable area, different issues can rise.

First, there is a risk that the pierced hole is larger than the cross section of the needle and that non-mixed beverage ingredient falls from said hole by sliding around the body of the needle. It can happen too that liquid beverage in preparation drops from said hole by sliding around the body of the needle though the needle is not in the beverage dispensing operation position. This leads to inconsistent preparation when a part of the ingredient is not mixed with water, to dirtiness when ingredient falls around the needle in the internal parts of the machine, to disappointing beverage aspect when non-mixed ingredient falls in the final drinking cup.

Secondly, there is a risk that the material of this openable area is not pierced or incorrectly pierced with the result that a part of this material covers the upper end of the needle inside the container volume, in particular the outlet end of the water conduit or the inlet end of the beverage outlet. The correct preparation of the beverage can be prevented.

Apart from the above problems linked to an optimal piercing for a correct beverage preparation, the material constituting the openable area must be made of a material that is food agreed since it is a part of the container that is in contact with the final beverage.

Finally, in a preferred manner, the materials used for the container should be made recyclable or compostable too.

An object of the invention is to address the above existing problems.

### SUMMARY OF THE INVENTION

In a first aspect of the invention, there is provided a beverage production system comprising a pack and a module for producing a beverage from the pack,
said pack comprising a beverage ingredient, said ingredient being configured to be mixed with a fluid to produce a beverage, said pack presenting a plane shape oriented along a plane (P), said pack comprising a bottom side, and said bottom side of said pack comprising an area configured for being openable, and
said module comprising:
   a pack holder assembly adapted for holding said pack in an essentially vertical position inside the module, and
   a fluid processing device comprising a body, said body comprising:
      an upwardly pointed end, and
      at least one internal inlet conduit for introducing a fluid into said pack for the preparation of a beverage by mixing said fluid with an ingredient contained in said pack, and
      at least one internal outlet conduit for dispensing said beverage from said pack, and
      an actuating device
to move said fluid processing device and said pack one to the other so that the upwardly pointed end opens the openable area of the bottom side of said pack, and
to position said fluid processing device and said pack one to the other in an operative position, wherein, in said operative position, the part of said fluid processing device comprising the pointed end protrudes inside the internal volume of the pack in order to introduce the fluid from the inlet conduit end and to dispense the beverage through the outlet conduit end,
and

wherein the openable area of the pack is made of a film of material, said film of material being first stretchable around the upwardly pointed end, and then pierceable by the upwardly pointed end during the upward movement of the fluid processing device through the openable area.

This system comprises a pack comprising a food or beverage ingredient able to produce a beverage further to mixing with an aqueous fluid, preferably water.

This food or beverage ingredient packed in the package can be a water soluble powder or a soluble concentrate in liquid or semi-liquid form. In that embodiment water dissolves or dilutes the beverage ingredient. The ingredient can be selected within the list of: soups, fruit juices, vegetable juices, bouillons, coffee, chocolate, tea, milk or creamer, smoothies, purees, coulis, creams or any combination thereof. Preferably, the food or beverage ingredient is a soluble or dilutable food or beverage ingredient selected in the list of:
instant coffee powder, milk powder, cream powder, instant tea powder, cocoa powder, soup powder, fruit powder or mixture of said powders,
a coffee concentrate, a milk concentrate, a syrup, a fruit or vegetable concentrate, a tea concentrate, a fruit or vegetable puree.

The powders can be agglomerated or sintered.

This food or beverage ingredient packed in the package can also contain a food or beverage ingredient able to be infused like a roast and ground coffee, or tea leaves. In that embodiment water extracts the beverage ingredient.

The pack presents a plane shape oriented along a plane (P) extending between a bottom side and an upper end.

An area of this bottom side is configured for being openable in order to introduce the aqueous fluid inside the pack and then to dispense the prepared beverage from the pack. Preferably, this area is configured for being openable by piercing, tearing, perforating or puncturing in particular by applying a pointed, tapered or sharp device, such as the fluid processing device, to said area. Preferably this openable area is positioned at the middle of the transversal dimension of the longitudinal shape of the pack.

In addition, the system comprises a module for producing a beverage. This module comprises a pack holder assembly configured to hold the pack within the module, a fluid processing device configured to introduce fluid in a pack that is present in the pack holder assembly and an actuating device to move the fluid processing device and the pack hold in the module one to the other.

Usually, this pack holder assembly comprises a pack chamber adapted for receiving a pack for a beverage preparation inside the module.

The pack chamber is configured for holding the pack in an essentially vertical position inside the module. This vertical position guarantees the efficient preparation of the beverage and particularly the dispensing of the beverage from the pack so that the less possible liquid remains inside the pack at the end of the extraction and when the pack must be removed from the system to be thrown to the bin. The pack chamber can comprise an upper pack inlet to introduce the new pack and

Preferably the pack chamber presents a bottom opening configured to enable an access of a fluid processing device to the bottom of said pack hold in the chamber. This access or passage is particularly designed to enable the relative movement of the fluid processing device to the bottom of the pack when it is hold inside the pack holder assembly.

The fluid processing device comprises a body that comprises an upwardly pointed, tapered or sharp end. This end is designed to open the bottom side of the pack, preferably by piercing, when this tip end is moved upwardly against the bottom side of the pack or alternatively the pack is moved downwardly to the fluid processing device.

The body of the fluid processing device comprises at least one internal inlet conduit for introducing a fluid into the pack. This fluid enables the preparation of a beverage by mixing with an ingredient contained in the pack.

The body of the fluid processing device comprises at least one internal outlet conduit for dispensing the prepared beverage. This beverage outlet is distinct from the inlet conduit.

Inlet and outlet conduits are provided inside the body of the fluid processing device which enables a better guidance of the liquids in and out of the pack, meaning no loss of liquids, no dirtiness and optimal preparation and dispensing.

Usually, the ends of the inlet and outlet conduits emerge close to the upwards end of the body of the fluid processing device

Due to the presence of two conduits inside the fluid processing device, generally, the fluid processing device presents a rather large transversal section. For a fluid processing device presenting a circular transversal section, usually the diameter of the fluid processing device is of at least 5 mm, usually at most 15 mm, preferably comprised between 5 and 12 mm, even more preferably comprised between 6 and 10 mm.

This fluid processing device is movable between two different positions, said positions comprising:
one position where the device is out of the pack and
another operative position where the device is positioned inside the pack during the beverage preparation and beverage dispensing.

The fluid processing device is moved by an actuating device from the stand-by position to the operative position.

The upwardly pointed end of the body is designed to open the bottom side of the pack when this pointed end is urged against the openable area of the pack that is hold in the pack holder. When the operative position is reached, the pointed end protrudes inside the internal volume of the pack so that the respective ends of both conduits emerge inside the pack, that is to say the end of the internal inlet conduit emerges in this internal volume and the end of the internal outlet conduit is positioned in this internal volume. Accordingly, introduced aqueous fluid and prepared beverage are urged to circulate through these internal conduits only.

Generally, in the operative position, the pointed end of the fluid processing device extends by about 10 mm, preferably 13 mm, above the openable area of the pack.

The openable area of the pack is made of a film of material that is designed so that, during the movement of the fluid processing device through the openable area, this material is first stretched around the upwardly pointed end of the fluid processing device before being pierced. Preferably, the film of material is sufficiently stretchable so as not break until the ends of the internal conduits of the fluid inlet and the beverage outlet emerge in the internal volume of the pack. As a result, when the film of material is pierced, the risk of ingredient falling through the pierced hole and around the fluid processing device is minimized, the pierced film remaining stretched around the part of the body that is below the ends of the conduits.

Stretchable property provides the advantage of enabling tightness around the body once the fluid processing device is in the operative position.

Simultaneously, the membrane should not be too stretchable with the risk of not being pierced by the needle or being not pierced, or slightly pierced, and still covering the ends of the conduits.

Preferably the bottom side of the pack can comprise
an external primary sheet of flexible material, said primary sheet comprising a first opening at the openable area,
an intermediate secondary sheet of a second material, said secondary sheet covering the first opening, and
an internal piece of a third reinforcing material, said piece comprising a second opening, said second opening facing the first opening, and the intermediate secondary sheet forms the openable area.

For a better interaction with the fluid processing device, preferably, the second opening presents a shape that is identical to the shape of the transversal section of the fluid processing device. Generally, this shape is circular.

Preferably, the sizes of the first and second openings are a bit greater than the size of the transversal section of the fluid processing device. Accordingly, the fluid processing device is able to pass through the second opening while the pierced stretchable material is stretched by the fluid processing device. Preferably, when the shapes of the fluid processing device and the second opening are circular, the diameters of the second opening and the transversal section of the fluid processing device can differ by about 1 mm.

Preferably, the size of the first opening is greater than the size of the second opening and the size of the transversal section of the fluid processing device. Accordingly, the fluid processing device does not contact the edges of the first opening during the opening operation. Depending on the nature of the flexible material of the external primary sheet, it can be preferred to limit this contact for food safety.

Preferably, the rest of the pack is made of the same external primary sheet of flexible material as the bottom side of the pack.

Such a material provides the advantages of compactness, manufacturing speed (forming, filling, sealing can be performed in a row) and enhanced recycling capabilities depending on the nature of the material used. This flexible material is preferably water impermeable.

Flexible material can be selected in the list of:
fibre-based material, like paper, cardboard, cabasse-based, bamboo-based or starch-based material, cellophane or combination thereof, coated on the inner side with a sealant layer to form sealed edges, and preferably with a barrier coating between the fibre-based material and the sealant layer. Barrier coating are configured to create a barrier to oxygen, air and humidity.

Such a barrier can include:
a metallisation coating, a silicone oxide coating, an aluminium coating, an atomic layer deposition (ALD) coating,
plastic laminates,
metallised foils or alufoils
or any combination thereof.

Preferably, the flexible material is chosen from ecologically friendly materials, such as recyclable, biodegradable, industrially compostable or home compostable materials.

In the preferred embodiment, the external primary sheet of flexible material is a multilayer material comprising flexible paper, coated with a multilayer film that comprises a metalized bi-oriented polypropylene film and a polyethylene film. The polypropylene film provides barrier to oxygen, air and humidity and the polyethylene film provides the required sealant function with the secondary sheet of stretchable and pierceable material and for the sealing of the edges of the pack with each other.

Preferably, the internal piece of third reinforcing material is made of a fibre-based material, like paper, cardboard, cabasse-based, bamboo-based or starch-based material, cellophane or combination thereof. Usually this third reinforcing material presents a stronger grammage than the first material and is less flexible to provide the bottom side with some rigidity property.

The intermediate secondary sheet of stretchable and pierceable material can be comprised in the list of: polyethylene (PE), polypropylene (PP), polylactide (PLA), polyhydroxyalcanoates (PHA), polybutylene adipate terepthalate (PBAT), polybutylene succinate (PBS), polyvinyl alcohol (PVOH), starch-based polymers, a polymer comprising food-grade oxygen and/or moisture scavengers, or a combination thereof.

The selection of the stretchable and pierceable properties of the material for the intermediate secondary sheet nature may be adapted to:
the shape of the pointed end of the fluid processing device, and/or
to the speed of the fluid processing device during its upward movement.

For example, the pointed end of the fluid processing device may be more or less pointed, more or less sharp and, for the same sheet of second material, pierceability may be different.

Adaptation may be necessary too if the shape of the end of the fluid processing device is not axially symmetrical and the end does not interact first with the sheet of material at the centre of the second hole but close to the peripheral edge of this second hole.

In the preferred embodiment, the fluid processing device comprises a conical shaped end.

In the preferred embodiment, the intermediate secondary sheet can present an elongation at break along the machine direction that is greater than 80% and inferior to 160% and preferably comprised between 100% and 140%.

In the preferred embodiment, this intermediate secondary sheet can present a tensile modulus along the machine direction that is greater than 800 MPa and inferior to 1500 MPa.

In the preferred embodiment, this intermediate secondary sheet can present a tensile strength along the machine direction that is greater than 30 MPa and inferior to 60 MPa.

In one preferred embodiment, the intermediate secondary sheet can be a multilayer polymer film, said film comprising:
a first polymer-based layer presenting an elongation at break along machine direction inferior to 50%, and
a second polymer-based layer presenting an elongation at break along machine direction superior to 160%.

Usually, these two layers are co-laminated with at least one adhesive layer. Adhesive layers provide adhesion between these two layers and optionally between one of these layers with another material this intermediate secondary sheet is configured to be attached too.

In the preferred embodiment, the intermediate secondary sheet can be a multilayer polymer film wherein:
a first layer of the film is a polyethylene film, and
a second layer of the film is a metallised bi-oriented polypropylene film.

Usually, this multilayer polymer film is oriented in the pack so that the first layer of polyethylene film is sealed to the first primary sheet of flexible material and is the first layer of the intermediate secondary sheet to be pierced by the fluid processing device.

In particular, the film of the first layer can be a polyethylene film presenting a thickness of 30 μm and the film of the second layer can be a metallised bi-oriented polypropylene film presenting a thickness of 18 μm.

Preferably the external primary sheet of flexible material is a multilayer material comprising flexible paper, coated with a polyethylene film as a sealant layer. This polyethylene film of the external primary sheet can be of the same nature (grade) as the polyethylene film of the first layer of the intermediate secondary sheet. Accordingly, sealing is improved.

Preferably the external primary sheet of flexible material is a multilayer material comprising flexible paper, coated with a metalized bi-oriented polypropylene as a barrier layer. This metalized bi-oriented polypropylene can be of the same nature (grade) as the metalized bi-oriented polypropylene of the second layer of the intermediate secondary sheet. Accordingly, manufacturing supply is simplified.

In one preferred embodiment, the bottom side of the pack comprises an intermediate fourth sheet of a fourth material that is positioned between the internal piece of third reinforcing material and the intermediate secondary sheet. This fourth material facilitates the attachment of the intermediate secondary sheet to the internal piece of third reinforcing material in particular by covering the hole of the internal piece of third reinforcing material. Accordingly, this fourth sheet presents sealing property. This fourth sheet can be a polyethylene film used for its heat sealing properties.

In a second aspect, there is provided a pack according to Claims 9 to 13.

In a third aspect there is provided a method to manufacture a pack such as described above, said method comprising the steps of:
a)—piercing first holes in a sheet of first material,
b)—around each first hole, attaching an intermediate secondary sheet of second material and a piece of third reinforcing material, said piece comprising a second hole, so that said second hole faces the first hole,
c)—cutting the sheet of first material into individual blank sheets of first material, each individual blank sheet comprising one first hole covered by an intermediate secondary sheet of second material and a pierced piece of third reinforcing material,
d)—bending and shaping each individual blank sheet and sealing the lateral edges of said sheet to form a U-shaped pack,
e)—filling the U-shaped pack with beverage ingredient and sealing the top edge of the pack.

In one preferred embodiment, in step b), the intermediate secondary sheet of second material and the pierced piece of third reinforcing material form a single co-laminated reinforced piece before said materials are attached around each first hole of the sheet of first material. Consequently, step b) is simplified.

Preferably this single co-laminated reinforced piece is manufactured by:
piercing second holes in a sheet of third reinforcing material, then
laminating the intermediate secondary sheet of second material and the pierced sheet of third reinforcing material forming a laminated reinforced material, then
cutting the co-laminated sheets in pieces, each piece comprising one second hole.

In a fourth aspect there is provided the use of a pack such as described in the second aspect in a beverage production system such as described in the first aspect.

In the present application:
elongation at break, tensile modulus and tensile strength are provided according to ASTM D 882 at room temperature
machine direction relates to the machine direction orientation (MDO) of the polymer film during the manufacturing of said film.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIG. 1 is a schematic drawing of a beverage production system according to the invention,

FIG. 2 is perspective view and a cross section view of a fluid processing device that can be used in the beverage production system,

FIG. 3 is a view of the pack holder assembly of the module for producing a beverage,

FIG. 4A is a side view of the pack hold by the locking device and pierced by the fluid processing device,

FIG. 4B is an isolated bottom view of the pack hold by the locking device and pierced the fluid processing device,

FIG. 5 illustrates the pack that can be used in the beverage production system of the invention,

FIGS. 6A and 6B are schematic illustrations of the bottom side of the pack and the cooperation with the fluid processing device in the different operations of the system.

FIG. 7 illustrates a manner to manufacture the packs according to the invention.

### DETAILED DESCRIPTION OF EXEMPLARY EMBODIMENTS

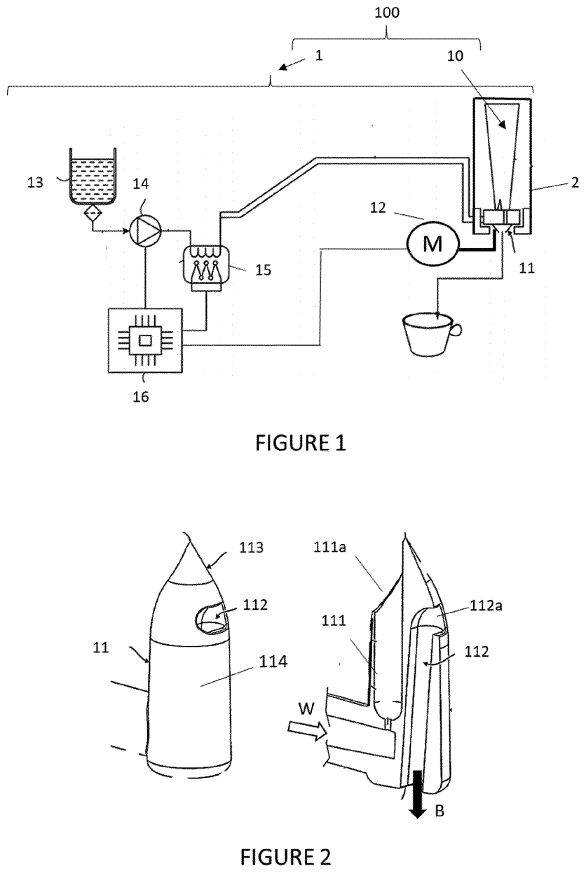

FIG. 1 illustrates schematically a beverage production system 100 according to the invention.

The system 100 comprises a module 1 and a pack 10. The module is adapted for receiving the pack and producing a beverage from said pack.

The module 1 comprises a pack holder assembly 2 and a fluid system to introduce a fluid inside the pack.

The fluid system usually comprises a fluid source 13, like a water tank, pumping means 14 to pump the fluid from the source. Usually heating and/or cooling means are part of the system to adapt the temperature of the fluid to be introduced inside the pack.

The fluid is supplied to a fluid processing device 11 configured to cooperate with the bottom of the pack in order to introduce the fluid in said pack.

Generally, the module comprises an actuating device 12 to move this fluid processing device 11 to said pack hold in the pack holder assembly 2.

The module comprises usually a system control unit 16 to control the above different devices for the preparation of a beverage from a pack.

Such a beverage production system 100 can correspond to the system described in the publications WO 2021/110650, WO 2021/110654 and/or WO 2021/110652.

FIG. 2 is perspective view and a cross section view of a fluid processing device 11 that can be used in the beverage production system.

The body of this device 11 comprises a main core part 114, that is preferably essentially cylindrical, and an upwardly pointed end 113, which preferably presents a conical shape extending from the main core part 114.

This body comprises:
an internal inlet conduit 111 for driving a fluid, preferably water, to the pointed end 113, as illustrated by the arrow W, and
an internal outlet conduit 112 for driving the prepared beverage from the internal volume of the pack in a downward direction as illustrated by arrow B.

By internal it is meant that these conduits extend inside the body and not along the surface of the body. Consequently, when the fluid processing device is introduced in a pack, liquids flow in and out of the pack through these internal conduits which provide a better guidance.

These both conduits are distinct one from the other. Each conduit 111, resp. 112 presents an end 111a, resp. 112a that emerges at the upper part of the body.

Preferably, the end 111a of the inlet conduit is designed so as to orientate a jet a fluid upwardly inside the pack.

The actuating device 12 (FIG. 1) is adapted to move this fluid processing device 11 to the pack 10 hold by the pack holder assembly 2 and in particular the pointed part 113 to the openable area 104 in order to open the openable area 104 or any membrane or cover provided at this area. In an alternative embodiment, the actuating device 12 can be adapted to move the pack to the openable area of the fluid processing device 11.

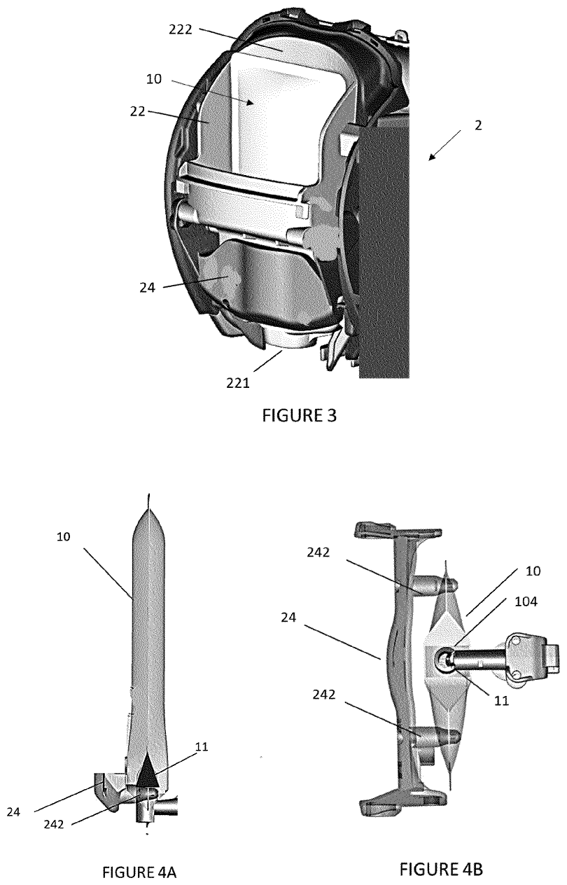

FIG. 3 is a view of the pack holder assembly 2 of the module 1. The assembly comprises a pack chamber 22 that presents a plane shape, said plane of the chamber being oriented in an essentially vertical position inside the module 1: it is adapted for holding the pack 10 so that the plane (P) of the pack extends along said plane of the chamber. The pack chamber comprises an upper pack inlet 222 to introduce a pack 10.

The chamber presents a bottom opening 221 configured to enable access to at least the bottom side of the pack hold in the chamber.

Preferably, the pack holder assembly 2 comprises a movable locking device 24 that is configured to fix the pack 10, in particular the bottom of the pack, inside the pack holder assembly when a beverage is prepared.

FIG. 4A is an isolated side view of the pack 10 hold by the locking device 24 and pierced by the fluid processing device 11 (schematically illustrated), said device protruding inside the internal volume of the pack in order to introduce the fluid. The device 11 has been previously introduced through the bottom side of the pack further to an upward vertical movement of the device, actuated by the actuating device (motor) of the module 1. Pins 242 of the locking device 24 retain the pack during that operation by cooperation with holes in the pack as described below.

FIG. 4B is the corresponding bottom view of the pack hold by the locking device and pierced by the fluid processing device showing the penetration of the fluid processing device 11 inside the openable area 104 of the pack at the bottom side.

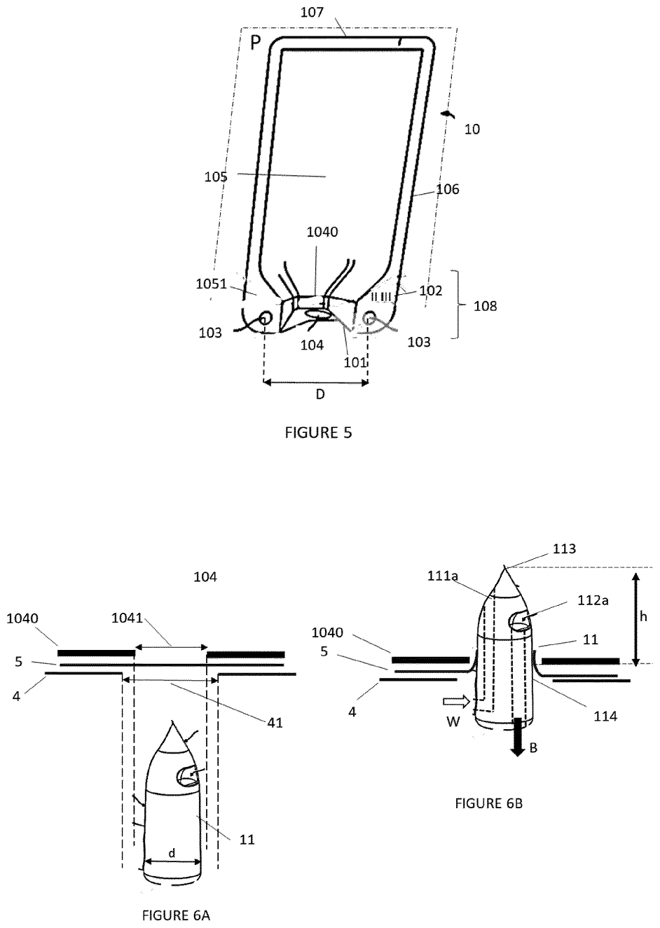

FIG. 5 is a perspective view of a pack 10 that can be used in the beverage production system 100 according to the invention.

This pack comprises an ingredient that is configured to be mixed with a fluid to produce a beverage. The pack presents a plane shape oriented along a plane P. Two longitudinal plane walls 105 (front and back) extends along this plane P.

In this specific embodiment, the walls 105 are made of a flexible material and the lateral edges 106 of these walls are sealed, as well as the edges at the top end 107. The bottom side 101 of said pack is configured for being openable. The bottom side 101 comprises an area 104 that is an openable area. This area 104 is configured for being openable by the fluid processing device 11 of the system. This openable area 104 is adapted to enable the introduction of the fluid processing device 11 so that said device protrudes inside the internal volume of the pack in order to introduce the fluid and to collect and dispense the beverage, as illustrated in FIG. 6B.

Preferably, the pack can comprise holes 103 at the bottom end and positioned around the openable area 104. These holes are adapted to cooperate with the two positioning means 242 of the movable locking device such as illustrated in FIGS. 4A, 4B. Precisely, the distance between the two holes correspond to the distance between the two pins 242 so that the locking device is able to move and position and fix the pack inside the chamber 22 during the opening of the openable area 104 by the fluid processing device 11 during its upwards movement and during the introduction of fluid in the pack from said device 10 protruding inside the internal volume of the pack.

In this illustrated embodiment the holes 103 are precisely positioned to be entered by the pins of the looking device. Preferably these holes are circular.

The pack 10 can comprise a readable code 102 in its bottom end and the module 1 can comprises a code reader inside or close to the chamber 22.

In the preferred illustrated embodiment of the pack of FIG. 5, the openable area 104 of the pack can comprise an internal piece 1040 of reinforcing material. This reinforcing material provides the advantage of defining a flat surface around the flexible openable area 104 which facilitates the introduction of the fluid processing device 11 inside the pack.

Generally, said piece of reinforcing material comprises an opening, said opening being closed by a pierceable material, that defines the openable area 104.

Generally, it is preferred that the opening of the piece of reinforcing material and the cross section of the fluid processing device present circular shapes as illustrated in the figures. Preferably, the diameter of the opening in the reinforcing material is greater than the diameter (d) of the transversal section of the fluid processing device by about 1 mm, said transversal section of the fluid processing device corresponding to the section positioned in the opening of the piece of reinforcing material when the fluid processing device 11 protrudes inside the internal volume of the pack in order to introduce the fluid as illustrated in FIGS. 4A and 6B.

FIGS. 6A and 6B illustrate the cooperation between the fluid processing device 11 and the openable area of the pack.

FIG. 6A illustrates the fluid processing device 11 positioned below the bottom side of the pack hold in the pack holder in a non-operative position and FIG. 6B illustrates the fluid processing device 11 that has been moved by the actuating device through the openable area and is placed in the operative position.

In these figures, the bottom side of the pack is described with the preferred embodiment. Yet other bottom side comprising stretchable and pierceable openable area 104 can be implemented.

In the preferred embodiment, the bottom side comprises
an external primary sheet 4 of a first material, said primary sheet comprising a first opening 41 at the openable area,
an intermediate secondary sheet 5 of a second material, said secondary sheet covering the first opening 41, and
an internal piece 1040 of a third reinforcing material, said piece comprising a second opening 1041, said second opening facing the first opening 41. The second and first openings 41, 1041 are usually aligned.

Preferably, the sizes of the first and second openings 41, 1041 are a bit greater than the size of the transversal section (d) of the fluid processing device. Accordingly, the fluid processing device 11 is able to pass through these both openings 41, 1041 as illustrated in FIG. 6B.

Preferably, when the shapes of the fluid processing device and the second opening 1041 are circular, the diameter of the second opening 1041 and the diameter d the transversal section of the fluid processing device can differ by about 1 mm.

Preferably the diameter of the first opening 41 and the diameter d the transversal section of the fluid processing device can differ by about 1 mm.

In particular, the above values (1 mm) apply for a diameter d of the transversal section of the fluid processing device comprised between 5 and 15 mm, preferably comprised between 5 and 12 mm, even more preferably comprised between 6 and 10 mm.

As illustrated in FIG. 6B, during the upward movement of the fluid processing device 11 through the openable area, the pointed end 113 passes through the second opening 1041 until the ends 111a, 112a of the conduits are positioned inside the internal volume of the pack. During this movement the device pierces the intermediate secondary sheet 5. Due to the particular stretchable property of the intermediate secondary sheet 5, the pierced film extends along a part of the external surface of the body of the fluid processing device 11 when it is in the operative position which prevents liquids from dripping between the external surface of the body of the fluid processing device and the edges of the openings 41, 1041.

This film material of the intermediate secondary sheet 5 is pierceable and stretchable. Yet these properties must be optimally balanced since:
if the film material is too easily pierceable before being stretched, the top end 113 of the fluid processing device would pierce the openable area before the cylindrical part 114 of the body is positioned inside the above the holes 41, 141, with the inconvenient that beverage ingredient stored in the pack would leak through said holes during the piercing operation.
if the film is too stretchable and not easily pierceable, there is a risk that the openable area 104 is not pierced and the pointed end 113 remains covered by the film or that the openable area is pierced but that the stretched film covers fully or partially at least one end 111a, 112a of the conduits which would prevent the normal beverage preparation.

Accordingly, this film material 5 shall present a ratio of pierceable and stretchable properties so that during the upward movement of the fluid processing device 11 through the openable area 104:
first the film material is stretched by the pointed end 113 of the fluid processing device without being pierced,
then as the pointed end is fully inside the pack (preferably the whole conical end with the preferred illustrated shape embodiment) the stretched film material is pierced.

Accordingly, at the beginning of the movement of the fluid processing device in the openable area, there is no risk that beverage ingredient escapes, and at the end of the movement there is less risk that the stretched film covers the ends of the conduits.

This ratio of pierceable and stretchable properties of the film material 5 must take into account the facts that:
the fluid processing device 11 is rather large since it comprises two internal conduits 111, 112 for different fluids. For at least this reason, as mentioned above, the diameter of this device is of at least 5 mm.
in the operative position (FIG. 6B), the fluid processing device 11 enters deeply inside the pack so that both the inlet conduit end 111a and the outlet conduit end 112a can be positioned inside the pack above the openable area and so that these ends 111a, 112a are not covered by the stretched film material. In this operative position, the pointed end 114 of the fluid processing device extends by about 10 mm, preferably 13 mm, above the openable area (as illustrated by length h in FIG. 6B).

Consequently, the film material must be able to stretch around this large diameter of the body of the processing device while the processing device extends deeply in the pack above the membrane.

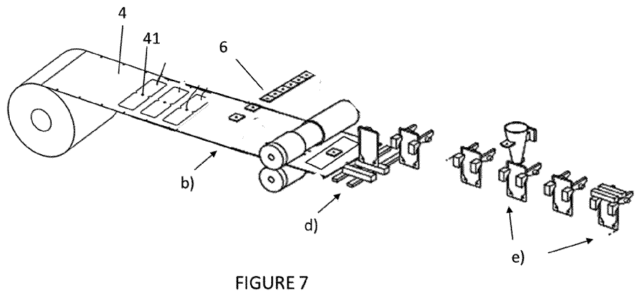

FIG. 7 illustrates a line for manufacturing the packs according to the invention with a forming machine. This machine is based on forming and sealing technology machines from the state of the art.

A sheet 4 of first material is taken from a roll. In this sheet the first openings 41 have already been pierced in zones corresponding to the future individual blank sheets of each pack. In an alternative embodiment, the first openings 41 can be pierced in the present manufacturing line from a roll of plane first material.

In a previous step not illustrated, co-laminated reinforced pieces 6 of the intermediate secondary sheet of second material and the pierced piece of third reinforcing material were formed. In the manufacturing line, one cut reinforced piece 6 is attached around each first opening 41 of the sheet 4 (step b).

Then the sheet 4 is cut into individual blank sheets comprising one first hole 41 covered by reinforced piece 6.

The individual blank sheets are bent and shaped and sealed around the lateral edges of said sheet to form a U-shaped pack (step d) that is filled with beverage ingredient (step e). Finally, the top edge of the pack is sealed (step e).

### Examples

Three different types of material were tested for use as the material of the intermediate secondary sheet in packs such as illustrated in FIGS. 5 and 6A.

In these different packs:
the first material of the external primary sheet 4 was paper (80 g/m²) with a barrier coating (metallised bi-oriented polypropylene film presenting a thickness of 16 μm) against air and moisture and a sealant layer (polyethylene film 30 μm thickness) to seal edges 106, 107 during pack forming and enable heat sealing with the second material of the intermediate secondary sheet,
the third material of the reinforcing piece 1040 was a multilayer material of a paper presenting a grammage of 130 g/m² and a polyethylene film presenting a grammage of 10 g/m² to enable heat sealing with the second material of the intermediate secondary sheet.

As for the second material of the intermediate secondary sheet, three different films of material were tested:
a metallised bi-oriented polypropylene film presenting a thickness of 16 μm (BOPPMet16),
a multilayer film of a metallised bi-oriented polypropylene film presenting a thickness of 18 μm and a polyethylene film presenting a thickness of 30 μm (BOPPMet18/PE30)
a metallised polyethylene film presenting a thickness of 38 μm (PEMet38)

These three films of material present different mechanical properties summarised in Tables A and B. These measures were realised according to ASTM D 882 at room temperature on several samples of each film.

TABLE A
Elongation at break in machine direction (%)

| | Average | Std deviation | Min | Max |
|---|---|---|---|---|
| BOPPMet16 | 31.6 | 1.4 | 30.1 | 33.0 |
| BOPPMet18/PE30 | 129.1 | 34.8 | 83.0 | 169.9 |
| PEMet38 | 206.1 | 50.3 | 159.5 | 159.5 |

TABLE B
Tensile strength in machine direction (MPa)

| | Average | Std deviation | Min | Max |
|---|---|---|---|---|
| BOPPMet16 | 216.7 | 8.3 | 195.1 | 228.2 |
| BOPPMet18/PE30 | 43.5 | 7.9 | 34.3 | 53.3 |
| PEMet38 | 18.2 | 1.1 | 16.8 | 19.3 |

Packs can be produced with these films and filled with soluble milk powder and then introduced in the beverage machine illustrated in FIG. 1, the machine comprising a fluid processing device such as illustrated in FIGS. 2A, 2B to produce milk.

Based on these measures, these packs can show the following features
in packs comprising BOPPMet16 as the second material of the intermediate secondary sheet, this sheet breaks as soon as the pointed end of the fluid processing is urged against it and some milk powder is falling below simultaneously.
in packs comprising PEMet38 as the second material of the intermediate secondary sheet, the sheet is not pierced by the pointed end of the fluid processing device due to its high stretchability property.
in packs comprising BOPPMet18/PE30 as the second material of the intermediate secondary sheet, this sheet is stretched by the pointed end and then pierced when this end is already inside the internal volume of the pack, then the pierced sheet remains stretched around the cylindrical body of the fluid processing device preventing liquid drops below.

Preferably, this intermediate secondary sheet can present a puncture force comprised between 5 and 8 N while implementing test method according to EN 14477 using a fluid processing device comprising a conical shaped end.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

system 100
module 1
   fluid processing device 11
   inlet conduit 111
   inlet conduit end 111a
   outlet conduit 112
   outlet conduit end 112a
   body tip end 113
   body cylindrical part 114
   actuating device 12
   fluid source 13
   pumping means 14
   heating and/or cooling means 15
   system control unit 16
pack holder assembly 2
   pack chamber 22
      bottom opening 221
      pack inlet 222
   locking device 24
      positioning means 242
pack 10
bottom side 101
code 102
hole 103
openable area 104
piece of reinforcing material 1040
second opening 1041
front, back wall 105
edges 106, 107, 1051
primary sheet 4
first opening 41
secondary sheet 5
co-laminated reinforced pieces 6

1. A beverage production system comprising a pack and a module for producing a beverage from the pack,
said pack comprising a beverage ingredient, said ingredient being configured to be mixed with a fluid to produce a beverage, said pack presenting a plane shape oriented along a plane, said pack comprising a bottom side, and said bottom side of said pack comprising an area configured for being openable, and
said module comprising:
a pack holder assembly adapted for holding said pack in an essentially vertical position inside the module, and
a fluid processing device comprising a body, said body comprising:
an upwardly pointed end, and
at least one internal inlet conduit for introducing a fluid into said pack for the preparation of a beverage by mixing said fluid with an ingredient contained in said pack, and
at least one internal outlet conduit for dispensing said beverage from said pack, and
an actuating device to move said fluid processing device and said pack one to the other so that the upwardly pointed end opens the openable area of the bottom side of said pack and position said fluid processing device and said pack one to the other in an operative position, wherein, in said operative position, the part of said fluid processing device comprising the pointed end protrudes inside the internal volume of the pack in order to introduce the fluid from the inlet and to dispense the beverage through the outlet,
and
wherein the openable area of the pack is made of a film of material, said film of material being first stretchable around the upwardly pointed end, and then pierceable by the upwardly pointed end, during the upward movement of the fluid processing device through the openable area.

2. A beverage production system according to claim 1, wherein the bottom side of the pack comprises:
an external primary sheet of a first material, said primary sheet comprising a first opening at the openable area,
an intermediate secondary sheet of a second material, said secondary sheet covering the first opening, and
an internal piece of a third reinforcing material, said piece comprising a second opening, said second opening facing the first opening,
wherein said intermediate secondary sheet forms the openable area.

3. A beverage production system according to claim 1, wherein the second material is selected from the group consisting of: polyethylene (PE), polypropylene (PP), polylactide (PLA), polyhydroxyalcanoates (PHA), polybutylene adipate terepthalate (PBAT), polybutylene succinate (PBS), polyvinyl alcohol (PVOH), starch-based polymers, a polymer comprising food-grade oxygen and/or moisture scavengers, and a combination thereof.

4. A beverage production system according to claim 1, wherein for the intermediate secondary sheet, the elongation at break along the machine direction is greater than 80% and less than 160%.

5. A beverage production system according to claim 1, wherein for the intermediate secondary sheet, the tensile modulus along the machine direction is greater than 800 MPa and less than 1500 MPa.

6. A beverage production system according to claim 1, wherein for the intermediate secondary sheet, the tensile strength along the machine direction is greater than 30 MPa and less than 60 MPa.

7. A beverage production system according to claim 1, wherein the intermediate secondary sheet is a multilayer polymer film, said film comprising:
a first polymer-based layer having an elongation at break along machine direction inferior to 50%, and
a second polymer-based layer having an elongation at break along machine direction superior to 160%.

8. A beverage production system according to claim 1, wherein the intermediate secondary sheet is a multilayer polymer film, wherein:
a first layer of the film is a polyethylene film, and
a second layer of the film is a metallised bi-oriented polypropylene film.

9. A beverage production system according to claim 1, wherein the fluid processing device presents a circular transversal section, and the diameter of the fluid processing device is of at least 5 mm.

10. A beverage production system according to claim 1, wherein, in the operative position, the pointed end of the fluid processing device extends by about 10 mm above the openable area of the pack.

11. A pack containing a beverage ingredient and configured for preparing a beverage by injection of fluid therein, wherein:
the beverage ingredient is a water soluble, dilutable or infusible beverage ingredient,
said pack presents:
a plane shape, said plane shape being oriented along a plane vertically oriented during beverage production, and
a bottom side comprising an area configured for being openable,
and
wherein the bottom side of the pack comprises:
an external primary sheet of a first material, said primary sheet comprising a first opening at the openable area,
an intermediate secondary sheet of a second material, said secondary sheet covering the first opening, and
an internal piece of a third reinforcing material, said piece comprising a second opening, said second opening facing the first opening,
wherein said intermediate secondary sheet forms the openable area, and
wherein, for said intermediate secondary sheet, the elongation at break along the machine direction is greater than 80% and less than 160%.

12. A pack according to the claim 1, wherein, for the intermediate secondary sheet, the tensile modulus along the machine direction is greater than 800 MPa and less than 1500 MPa.

13. A pack according to claim 11, wherein for the intermediate secondary sheet, the tensile strength along the machine direction is greater than 30 MPa and less than 60 MPa.

14. A pack according to claim 11, wherein the intermediate secondary sheet is a multilayer polymer film, said film comprising:
a first polymer-based layer presenting an elongation at break along machine direction inferior to 50%, and
a second polymer-based layer presenting an elongation at break along machine direction superior to 160%.

15. A pack according to claim 11, wherein the intermediate secondary sheet is a multilayer polymer film wherein:
the first polymer-based layer of this multilayer polymer film is a metallised bi-oriented PP film, and
the second polymer-based layer of this multilayer polymer is a PE film.

16. Method to manufacture a pack comprising the steps of:
a) piercing first holes in a sheet of first material,
b) around each first hole, attaching an intermediate secondary sheet of second material and a piece of third reinforcing material, said piece comprising a second hole, so that said second hole faces the first hole,
c) cutting the sheet of first material into individual blank sheets of first material comprising one first hole covered by an intermediate secondary sheet of second material and a pierced piece of third reinforcing material,
d) bending and shaping said individual blank sheets and sealing the lateral edges of said sheet to form a U-shaped pack, and
e) filling the U-shaped pack with beverage ingredient and sealing the top edge of the pack.

17. Method according to claim 16, wherein, in step b) the intermediate secondary sheet of second material and the pierced piece of third reinforcing material form a single co-laminated reinforced piece before said materials are attached on each first hole of the sheet of first material.

18. Method according to claim 16, wherein the single co-laminated reinforced piece is manufactured by:
piercing second holes in a sheet of third reinforcing material, then
laminating the intermediate secondary sheet of second material and the pierced sheet of third reinforcing material forming a laminated reinforced material, then
cutting the co-laminated sheets in pieces, each piece comprising one second hole.

19. (canceled)
